(19) United States
(12) Patent Application Publication
(10) Pub. No.: US 2023/0025234 A1
(43) Pub. Date: Jan. 26, 2023

(54) 3D PRINTER AND 3D PRINTING METHOD USING CUMULATIVE ILLUMINATION ALONG A SPECIFIC PATH

(71) Applicant: INDUSTRY-ACADEMIC COOPERATION FOUNDATION, DANKOOK UNIVERSITY, Yongin-si (KR)

(72) Inventors: Daekeun KIM, Seoul (KR); Hee Su Chung, Seoul (KR); Jae Hyun Lim, Hwaseong-si (KR); Ye Hyun Cho, Pocheon-si (KR)

(73) Assignee: INDUSTRY-ACADEMIC COOPERATION FOUNDATION, DANKOOK UNIVERSITY, Yongin-si (KR)

(21) Appl. No.: 17/408,421

(22) Filed: Aug. 21, 2021

(30) Foreign Application Priority Data
Jul. 20, 2021 (KR) 10-2021-0095179

(51) Int. Cl. B29C 64/277; B29C 64/232; B29C 64/236; B29C 64/393

(52) U.S. Cl. CPC B29C 64/277; B29C 64/232; B29C 64/236; B29C 64/393; B33Y 10/00

(57) ABSTRACT

A 3D printer includes: a tank containing a photocurable resin; a spatial light modulator disposed under the tank and selectively delivering light to a specific region of the photocurable resin, the spatial light modulator including a light source; a positioning stage disposed under the spatial light modulator and moving the spatial light modulator along multiple axes; and a controller controlling the spatial light modulator and the positioning stage, wherein the controller controls the spatial light modulator and the positioning stage such that the spatial light modulator is moved along a specific path and regions of the photocurable resin illuminated with the light partially overlap one another to allow a cumulatively illuminated region to be cured.

### ACKNOWLEDGEMENTS

This research was supported by the projects as below.

[Project number] GRRC dankook 2016-B04

[Ministry] Gyeonggi-do

[Management agency] Gyeonggi-do

[Program name] Gyeonggi do Regional Research Center (GRRC)

[Project name] Development of soft material based multi-layer structure product manufacturing platform

[Contribution ratio] 1/1

[Supervision institution] Dankook University, Korea (ROK)

[Period] 2021 Jul. 1˜2022 Jun. 30

### FIELD

The present invention relates a 3D printer and a 3D printing method using cumulative illumination along a specific path, and more particularly to a 3D printer and a 3D printing method using cumulative illumination along a specific path, in which light is selectively delivered to a photocurable resin on a per-pixel basis while moving stepwise along a specific path by a distance less than a pixel width such that, among regions cumulatively illuminated with the light, a region exposed to an energy greater than or equal to a curing threshold of the photocurable resin can be selectively cured, thereby providing significantly enhanced printing resolution.

### BACKGROUND

Digital light processing (DLP) is a technology used in a projector.

Photocuring 3D printing is a technology in which light patterned in the shape of an object to be modeled is projected onto a liquid photocurable resin using a DLP projector including a light source and a digital micromirror device (DMD) to cure the photocurable resin in the shape of the object, followed by stacking cured layers of the photocurable resin one above another.

Photocuring 3D printing is widely used these days since this technology ensures a uniform workflow and relatively high printing speed through layer-by-layer printing while achieving enhanced surface roughness and precision.

Here, the DMD consists of micromirrors, the number of which corresponds to printing resolution, wherein each of the micromirrors selectively reflects incident light.

A typical DLP 3D printer has a pixel-level resolution. Conventionally, in order to achieve a higher printing resolution, there has been used a method in which a photocurable resin is cumulatively illuminated through fine positioning of a DLP projector or using multiple light sources.

However, cumulative illumination of the photocurable resin through fine positioning of the DLP projector has problems in that the DLP projector needs to be repeatedly moved to each individual boundary point of a 3D model, which is difficult to implement and causes reduction in printing efficiency.

In addition, cumulative illumination of the photocurable resin using multiple light sources has problems in that a large number of light sources is needed, it takes a long time to complete printing due to the need to adjust the emission intensity of each light source for illumination of each region, and a complex algorithm is required.

As a similar device to the DLP projector, a spatial light modulator (SLM), which is a display device that modulates incident light according to positions thereof and optically transmits the modulated light, is implemented in various ways, such as an LCD (liquid crystal display), a liquid crystal on silicon (LCoS), and a digital micromirror device (DMD). However, the spatial light modulator has the same problems as above.

### RELATED LITERATURE

### Patent Document

(Patent Document 1) U.S. Ser. No. 10/001,641 B2 (title of invention: Enhanced resolution DLP projector apparatus and method of using same, publication date: 2018 Jun. 19)

### SUMMARY

Embodiments of the present invention are conceived to solve such problems in the art and it is an aspect of the present invention to provide a 3D printer and 3D printing method using cumulative illumination along a specific path, in which light is selectively delivered to a photocurable resin on a per-pixel basis while moving stepwise along a specific path by a distance less than a pixel width such that an energy greater than or equal to a curing threshold of the photocurable resin is accumulated on a region to be cured, thereby providing significantly enhanced printing resolution.

It will be understood that aspects of the present invention are not limited to the above one. The above and other aspects of the present invention will become apparent to those skilled in the art from the detailed description of the following embodiments in conjunction with the accompanying drawings.

In accordance with one aspect of the present invention, a 3D printer using cumulative illumination along a specific path includes: a tank containing a photocurable resin; a spatial light modulator disposed under the tank and selectively delivering light to a specific region of the photocurable resin, the spatial light modulator including a light source; a positioning stage disposed under the spatial light modulator and moving the spatial light modulator along multiple axes; and a controller controlling the spatial light modulator and the positioning stage, wherein the controller controls the spatial light modulator and the positioning stage such that the spatial light modulator is moved along a specific path and regions of the photocurable resin illuminated with the light partially overlap one another to allow a cumulatively illuminated region to be cured.

The controller may control the positioning stage to move the spatial light modulator stepwise along the specific path by a distance less than a pixel width.

The spatial light modulator may further include a digital micro-reflector including an array of micromirrors each selectively reflecting the light from the light source, the number of micromirrors corresponding to the number of pixels, and the controller may control the digital micro-reflector to reflect the light at a different intensity for each pixel along the specific path.

The spatial light modulator may further include a digital micro-transmitter including an array of LCD cells each selectively transmitting the light from the light source, the number of LCD cells corresponding to the number of pixels, and the controller may control the digital micro-transmitter to transmit the light at a different intensity for each pixel along the specific path.

The spatial light modulator may further include a digital microcell reflector including an array of LCoS cells each selectively reflecting the light from the light source, the number of LCoS cells corresponding to the number of pixels, and the controller may control the digital microcell reflector to reflect the light at a different intensity for each pixel along the specific path.

In accordance with another aspect of the present invention, a 3D printing method using cumulative illumination along a specific path includes: slicing a target 3D model into multiple cross-sectional images; dividing each pixel of the cross-sectional image into multiple segments; generating an illumination algorithm for modeling the multiple cross-sectional images such that regions illuminated with light overlap one another with reference to the segments along the specific path; delivering the light to a photocurable resin along the specific path based on the illumination algorithm; and stacking a photocured layer of the photocurable resin.

The illumination algorithm may be implemented such that the light is delivered to the photocurable resin while moving stepwise along the specific path by a distance less than a pixel width.

The illumination algorithm may be implemented such that the light is delivered to the segment to be cured at a different intensity for each pixel along the specific path.

The illumination algorithm may be implemented such that the light has an energy less than a curing threshold of the photocurable resin and an energy greater than the curing threshold of the photocurable resin is accumulated on the segment to be cured.

The 3D printer and the 3D printing using cumulative illumination along a specific path according to the present invention provide at least one of the following benefits.

According to the 3D printer and the 3D printing method using overlapping light irradiation along a specific path of the present invention, there are one or more of the following effects.

First, a region cumulatively illuminated can be selectively cured through accumulation of energy thereon, thereby reducing overcure.

Second, a spatial light modulator illuminates a photocurable resin in a cumulative manner while moving stepwise by a specific distance less than a pixel width, thereby enhancing 3D printing resolution from pixel-level resolution to subpixel-level resolution.

Third, a digital micro-reflection or digital transmission device reflects incident light at different intensities on a per-pixel basis, thereby varying the degree of curing of each pixel.

Fourth, each pixel is divided into multiple segments and an algorithm is implemented such that a segment to be cured can be cumulatively illuminated, whereby printing resolution can be enhanced in proportion to the number of segments.

It will be understood that advantageous effects of the present invention are not limited to the above ones, and the above and other advantageous effects of the present invention will become apparent to those skilled in the art from the detailed description of the following embodiments in conjunction with the accompanying drawings.

### DRAWINGS

FIG. 1 is a view of a 3D printer using cumulative illumination along a specific path according to one embodiment of the present invention.

FIG. 2 is a view of a spatial light modulator of the 3D printer according to one embodiment of the present invention.

FIG. 3 is a view of a digital micro-reflection or digital transmission device of the 3D printer according to one embodiment of the present invention.

FIG. 4 is a view of a tank and stages of the 3D printer according to one embodiment of the present invention.

FIG. 5 is a view illustrating a result of printing by the 3D printer according to one embodiment of the present invention.

FIG. 6 is a flowchart of a 3D printing method using cumulative illumination along a specific path according to one embodiment of the present invention.

FIG. 7 is a view illustrating a pixel division step of the 3D printing method according to one embodiment of the present invention.

FIG. 8 is a view illustrating an illumination algorithm generation step of the 3D printing method according to one embodiment of the present invention.

FIG. 9 is a view illustrating an illumination step of the 3D printing method according to one embodiment of the present invention.

FIG. 10 is a view illustrating an illumination step of the 3D printing method according to another embodiment of the present invention.

### DETAILED DESCRIPTION

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are provided for complete disclosure and thorough understanding of the present invention by those skilled in the art. The scope of the present invention is defined only by the claims. Like components will be denoted by like reference numerals throughout the specification.

In the drawings, the size or shape of components may be exaggerated for descriptive convenience and clarity only. It should be noted that the same components may be denoted by same reference numerals. In addition, description of known functions and constructions which may unnecessarily obscure the subject matter of the present invention will be omitted.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

When an element or layer is referred to as being “on,” “connected to,” or “coupled to” another element or layer, it may be directly on, connected to, or coupled to the other element or layer or intervening elements or layers may be present. However, when an element or layer is referred to as being “directly on,” “directly connected to,” or “directly coupled to” another element or layer, there are no intervening elements or layers present. The same is applied to other expressions for describing a relationship between elements.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

As used herein, terms such as “upper,” “lower,” “above,” “below,” and the like, are intended to represent a relative position of one element with respect to another element. These spatially relative terms are defined with reference to the drawings and do not indicate absolute orientations. In other words, “upper portion” may be defined as “lower portion” and vice versa without departing from the spirit and scope of the invention.

Hereinafter, exemplary embodiments of a 3D printing method using cumulative illumination along a specific path and a 3D printer employing the same will be described with reference to the accompanying drawings.

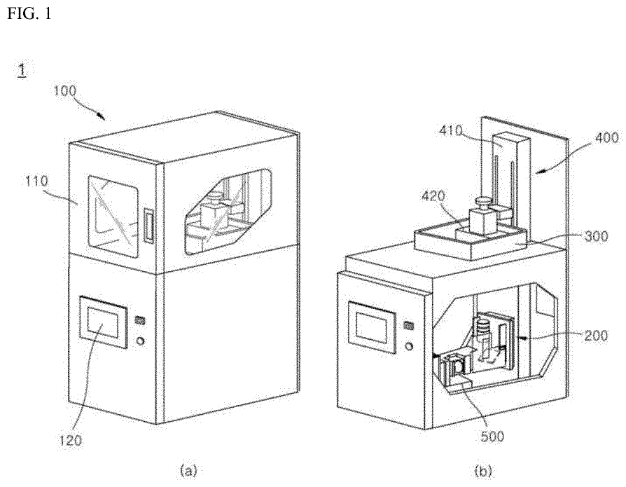

FIG. 1 is a view of a 3D printer using cumulative illumination along a specific path according to one embodiment of the present invention. FIG. 1(a) is a view of a housing 100 of the 3D printer, and FIG. 1(b) is a view of an inside of the housing 100.

Referring to FIG. 1, a 3D printer 1 using cumulative illumination along a specific path according to one embodiment of the present invention includes a housing 100, and a spatial light modulator 200 disposed inside the housing, a tank 300 disposed above the spatial light modulator and containing a photocurable resin, a stacking stage 400 adapted for a cured layer of the photocurable resin to be stacked thereon, a positioning stage 500 moving the spatial light modulator 200 in multiple axial directions, and a controller (not shown) controlling the spatial light modulator 200, the stacking stage 400, and the positioning stage 500.

The spatial light modulator 200 and the positioning stage 500 described below may be disposed at a lower inside of the housing 100, and the tank 300 and the stacking stage 400 described below may be disposed at an upper inside of the housing 100.

A door 110 providing access to the inside of the housing 100 may be formed on one surface of the housing 100 toward the tank 300 and the stacking stage 400 to fill the tank 300 with the photocurable resin or to remove a complete printed object from the housing. In addition, the housing may be provided with a display 120 at one side of an outer surface thereof. The display 120 may display information about progress of a print job performed by the 3D printer 1 and operation of the 3D printer 1 and may include a touchscreen module (not shown) receiving input of an operation command.

The spatial light modulator 200 may illuminate the photocurable resin contained in the tank 300 described below. Although the spatial light modulator 200 may be disposed under the tank 300 as shown in FIG. 1 to illuminate the photocurable resin through a lower surface of the tank 300, it will be understood that the present invention is not limited thereto. In another embodiment, the spatial light modulator 200 may be disposed above the tank 300 to illuminate the photocurable resin through an upper surface of the tank 300.

Here, the spatial light modulator 200 may be a liquid crystal display (LCD) projector, a liquid crystal on silicon (LCoS) projector, a digital light processing (DLP) projector, or a spatial light modulator (SLM).

The tank 300 may be provided in the form of a box open at a top thereof to receive the photocurable resin therein. When the spatial light modulator 200 is disposed under the tank 300, the lower surface of the tank 300 may include a transparent fluorinated ethylene propylene (FEP) film to transmit light from the spatial light modulator 200 to the photocurable resin therethrough.

The stacking stage 400 may be disposed above the tank 300 and may include a z-axis linear rail 410 and a stacking plate 420. After completion of illumination of one layer of the photocurable resin using the spatial light modulator 200, the stacking plate 420 may be raised to a specific height by the z-axis linear rail 410 such that the cured layer of the photocurable resin can be stacked on the stacking plate 420.

In the other embodiment in which the spatial light modulator 200 is disposed above the tank 300, the stacking plate 420 may be disposed inside the tank 300 and may be lowered to a specific height by the z-axis linear rail 410 after completion of illumination of one layer of the photocurable resin using the spatial light modulator 200, such that the cured layer of the photocurable resin can be stacked on the stacking plate 420.

The positioning stage 500 may be disposed under the spatial light modulator 200 and may be coupled to the spatial light modulator 200 to move the spatial light modulator 200 in multiple axial directions by a distance less than a pixel width of an image projected by the spatial light modulator 200.

The controller (not shown) may control the spatial light modulator 200, the stacking stage 400, and the positioning stage 500. The controller may control the positioning stage 500 such that the spatial light modulator is moved stepwise along a specific path by a distance less than the pixel width.

In addition, the controller may control the spatial light modulator 200 and the positioning stage 500 such that regions of the photocurable resin illuminated with the light from the spatial light modulator moving along the specific path can partially overlap one another. Here, the specific path may be, for example, a path along which the spatial light modulator is moved stepwise clockwise or counterclockwise by a distance corresponding to half the pixel width until reaching a starting point.

Here, the region of the photocurable resin cumulatively illuminated may be selectively cured, thereby providing enhanced printing resolution.

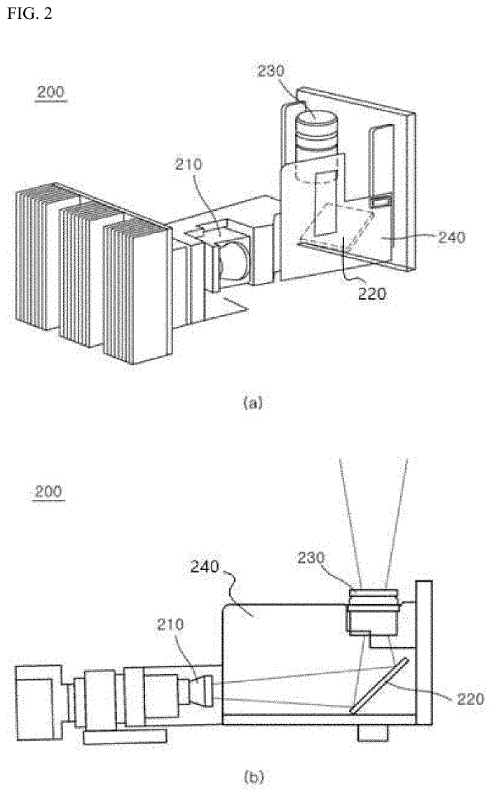

Now, the 3D printer 1 using cumulative illumination along the specific path according to the embodiment of the present invention will be described in more detail with reference to FIG. 2 to FIG. 4.

FIG. 2 is a view of the spatial light modulator 200 of the 3D printer (1 of FIG. 1) according to one embodiment of the present invention. The spatial light modulator 200 according to this embodiment is a DLP projector, and embodiments in which the spatial light modulator is an LCD projector or an LCoS projector will be described further below.

Referring to FIG. 2, the spatial light modulator 200 may include a light source 210, a digital micro-reflector 220 including an array of micromirrors, the number of which corresponds to printing resolution, each of the micromirrors selectively reflecting light emitted from the light source 210 on a per-pixel basis, an imaging lens 230 refracting the light reflected from the digital micro-reflector 220 to form an image having a specific size on the photocurable resin contained in the tank (300 of FIG. 1), and a controller 240 controlling the light source 210 and the digital micro-reflector 220.

Although the light source 210 may be a UV LED, it will be understood that the present invention is not limited thereto and the light source 210 may include any light source that emits light capable of curing the photocurable resin.

The digital micro-reflector 220 may reflect the light emitted from the light source 210 at different intensities on a per-pixel basis. Specifically, the micromirrors, the number of which corresponds to the number of pixels of the printing resolution, may be tilted to a specific angle by the controller 240 described below to selectively reflect the light on a per-pixel basis. For example, a micromirror in an ON position may reflect the light toward the photocurable resin, whereas a region of the photocurable resin corresponding in location to a micromirror in an OFF position may not be illuminated with the light.

The imaging lens 230 may refract the light reflected from the digital micro-reflector 220 to form an image having a specific size on a specific region of the photocurable resin located adjacent to the stacking stage (400 of FIG. 1) or adjacent to a cured layer of the photocurable resin stacked on the stacking stage 400. Accordingly, regions of the photocurable resin can be sequentially cured and stacked on the stacking plate 420 in order of proximity to the stacking plate 420.

The controller 240 may control the light source 210 and the digital micro-reflector 220. Specifically, the control unit 240 may allow the light to be delivered to the photocurable resin at different intensities on a per-pixel basis through control over the emission intensity of the light source 210 or through individual control over each of the micromirrors of the digital micro-reflector 220.

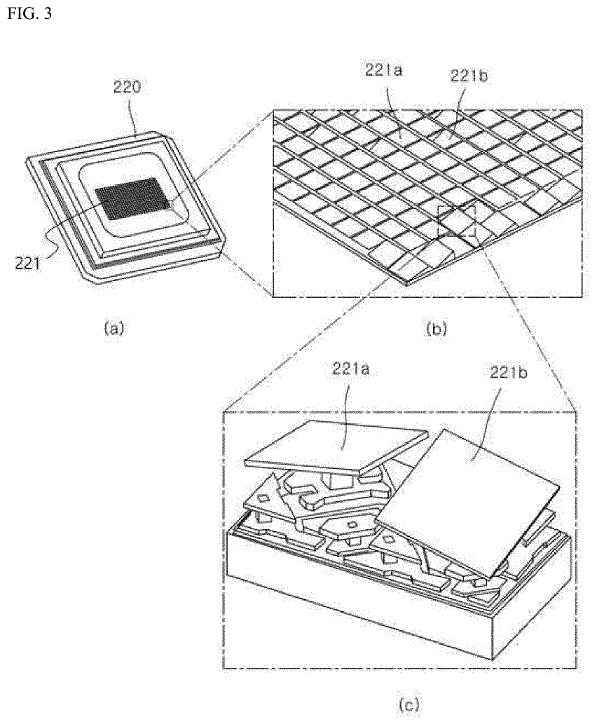

Next, the digital micro-reflector 220 will be described in detail with reference to FIG. 3.

FIG. 3 is a view of the digital micro-reflector 220 of the 3D printer using cumulative illumination along the specific path according to one embodiment of the present invention.

FIG. 3(a) is a view of the digital micro-reflector 220 including multiple micromirrors 221, FIG. 3(b) is an enlarged view of the multiple micromirrors 221 of the digital micro-reflector 220, and FIG. 3(c) is a view illustrating positions of the micromirrors 221.

Referring to FIG. 3(a), the digital micro-reflector 220 may be a digital micromirror device (DMD). Referring to FIG. 3(b), the digital micro-reflector 220 may include micromirrors, the number of which corresponds to the printing resolution, wherein the micromirrors may correspond to respective pixels.

The multiple micromirrors 221 may be tilted at different angles and may be switched between an ON position and an OFF position. Referring to FIG. 3(c), a micromirror 221a in the ON position may be tilted at a specific angle that allows the micromirror 221a to reflect the light from the light source (210 of FIG. 2) toward the photocurable resin. In addition, a micromirror 221b in the OFF state may be tilted at a specific angle that allows the micromirror 221b not to reflect the light from the light source 210 toward the photocurable resin.

Accordingly, a region of the photocurable resin located on a pixel corresponding to the micromirror 221a in the ON position is illuminated with the light from the light source 210, whereas a region of the photocurable resin located on a pixel corresponding to the micromirror 221b in the OFF position is not illuminated with the light from the light source 210.

That is, the multiple micro-mirrors 221 allow selective illumination of the photocurable resin on a per-pixel basis.

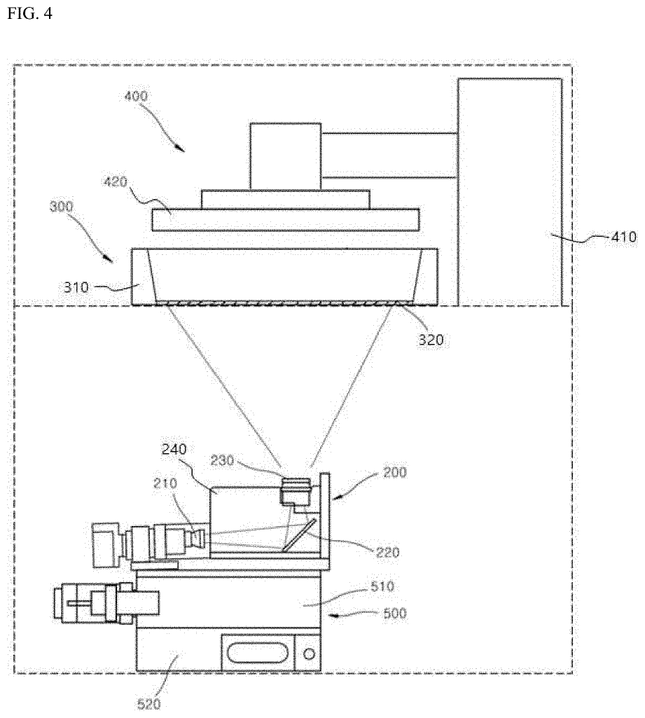

FIG. 4 is a view of the tank 300, the stacking stage 400, and the positioning stage 500 of the 3D printer according to one embodiment of the present invention.

With reference to the drawing, the vertical axis is referred to as a z-axis and the horizontal plane is referred to as an x-y plane defined by an x-axis and a y-axis, for convenience of description.

Referring to FIG. 4, the tank 300 may include a box-shaped tank frame 310 open at a top thereof to receive the photocurable resin therein and a transparent fluorinated ethylene propylene (FEP) film 320 forming a bottom of the tank frame 310.

Since the tank 300 has the bottom formed of the transparent FEP film 320, the light emitted from the spatial light modulator 200 can pass through the tank 300 to cure the photocurable resin in the tank 300.

The stacking stage 400 may be disposed above the tank 300 and may have a smaller size than the opening of the tank 300 such that the stacking plate 420 adapted for a cured layer of the photocurable resin to be stacked thereon can be inserted into the tank 300 to directly contact the photocurable resin.

In addition, the stacking stage 400 may include a z-axis linear rail 410 to adjust the stacking stage 400 to a height that allows a cured layer of the photocurable resin to be stacked on the stacking stage 400.

The positioning stage 500 may be disposed under the spatial light modulator 200 to move the spatial light modulator 200 stepwise along a specific path by a distance less than the pixel width in multiple axial directions.

When the positioning stage 500 includes an x-axis linear rail 510 and a y-axis linear rail 520 as shown in FIG. 4, the spatial light modulator 200 may be moved stepwise along the specific path by a specific distance along the x-axis and the y-axis.

Operation of the spatial light modulator 200, the stacking stage 400, and the positioning stage 500 may be controlled by the control unit 240. Here, the controller 240 may control the spatial light modulator 200, the stacking stage 400, and the positioning stage 500 at the same time.

Next, another embodiment in which the spatial light modulator 200 is an LCD projector (not shown) will be described.

When the spatial light modulator 200 is an LCD projector, a transmission amount of the light emitted from the light source is adjusted by a digital micro-transmitter.

Specifically, the LCD projector includes a digital micro-transmitter including an array of LCD cells each electively transmitting the light from the light source therethrough. Here, the number of LCD cells corresponds to the number of pixels. Here, the digital micro-transmitter is controlled to transmit the light at different intensities on a per-pixel basis along the specific path, as in the above embodiment.

In a further embodiment in which the spatial light modulator 200 is an LCoS projector (not shown), a reflection amount of the light emitted from the light source is adjusted by a digital microcell reflector.

Specifically, the LCoS projector includes a digital microcell reflector including an array of LCoS cells each selectively reflecting the light from the light source. Here, the number of LCoS cells corresponds to the number of pixels. As in the above embodiment, the digital microcell reflector is controlled to reflect the light at different intensities on a per-pixel basis along the specific path.

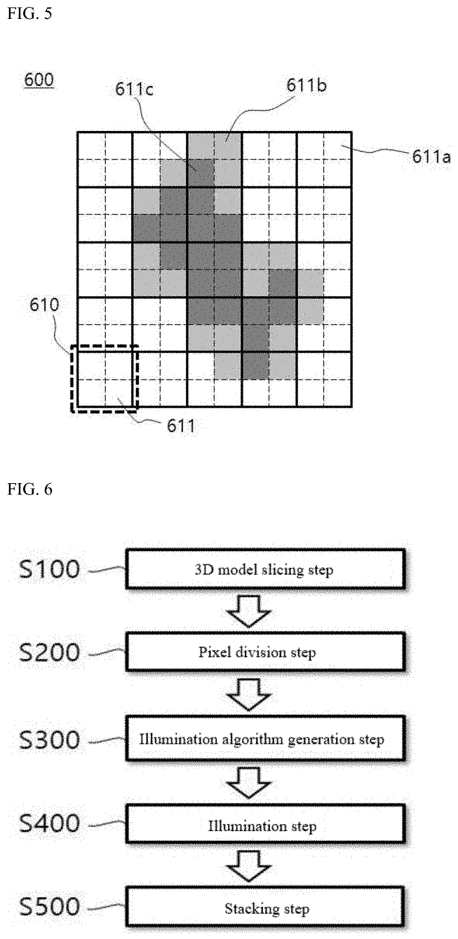

Next, the mechanism of the 3D printer described with reference to FIG. 4 and an exemplary print job performed by the 3D printer will be described with reference to FIG. 5.

When a photocurable material 600 to be modeled is divided on the basis of printing pixels 610 as shown in FIG. 5, the 3D printer according to the present invention can selectively cure sections 611 smaller than the pixel 610.

When the positioning stage (500 of FIG. 4) moves the spatial light modulator (200 of FIG. 4) along the specific path in multiple axial directions by a distance smaller than a width of the pixel 610, the light source (210 of FIG. 4) illuminates the photocurable material 600 with light having an energy less than a curing threshold of the photocurable material 600, whereby only a section 611c exposed to an energy greater than or equal to the curing threshold through cumulative illumination can be selectively cured. Here, a non-illuminated section 661a and a section 611b exposed to an energy less than the curing threshold are not cured, thereby enabling higher resolution printing.

FIG. 6 is a flowchart of a 3D printing method using cumulative illumination along a specific path according to one embodiment of the present invention.

Referring to FIG. 6, the 3D printing method using cumulative illumination along the specific path according to this embodiment may include a 3D model slicing step (S100), a pixel division step (S200), an illumination algorithm generation step (S300), an illumination step (S400), and a stacking step (S500).

The 3D model slicing step (S100) may include slicing a target 3D model into multiple horizontal cross-sectional images.

Here, a slicing interval may be determined according to 3D printing conditions and environments, and the height of the multiple cross-sections may be constant.

The pixel division step (S200) may include dividing each pixel in the cross-sectional image into a specific number of smaller segments. Although the number of segments may be determined according to user input or may be determined according to the resolution of the cross-sectional image to enhance printing resolution, the number of segments may be determined according to 3D printing conditions since a minimum size of the segments, which is smaller than that of the pixel, is limited by the 3D printing conditions.

Preferably, each pixel in the cross-sectional image is divided into a square number of segments, for example, 4 or 9 segments, without being limited thereto. In addition, each pixel in the cross-sectional image may be divided into the same number of segments to speed up calculation in the illumination algorithm generation step (S300) described below.

The illumination algorithm generation step (S300) may include generating an illumination algorithm based on the number of segments determined in the pixel division step (S200).

The number of times of performing illumination may be determined according to the number of segments of the pixel, and the illumination algorithm may be implemented such that illumination is performed along the specific path on the basis of the number of segments while allowing overlap between illumination regions.

Specifically, the illumination algorithm may be implemented such that only a curing target region of the photocurable resin can be cured through cumulative illumination while the illumination region is moved along the specific path across the segments.

Here, the specific path is a movement path of the illumination region along the segments and may be a path along which the illumination region is moved stepwise by a distance less than the pixel width. For example, the specific path may be a path along which the illumination region is moved clockwise or counterclockwise until reaching a starting point.

Light delivered to the photocurable resin may have an energy less than a curing threshold of the photocurable resin, and an energy greater than or equal to the curing threshold of the photocurable resin may be accumulated on a region to be cured, which is illuminated with the light multiple times.

In addition, the illumination algorithm may be implemented such that the intensity of the light delivered to the segments to be cured is controlled for each pixel on the specific path.

Here, the intensity of the light may refer to the energy of the light.

A series of illumination algorithms may be generated with respect to the multiple cross-sectional images in the order of printing.

In the illumination step (S400), the illumination algorithm is executed, whereby the photocurable resin can be illuminated while the illumination region is moved along the specific path across the segments.

The stacking step (S500) may include a procedure in which, after the illumination step (S400) is performed with respect to one cross-sectional image using the illumination algorithm, the illumination step (S400) is performed with respect to the next cross-sectional image, followed by stacking a modeled layer of the photocurable resin on a previous modeled layer of the photocurable resin.

The stacking step (S500) may be repeated until modeling of all the cross-sectional images of the 3D model is completed. Here, completion of modeling of the 3D model may mean completion of the illumination step (S400) with respect to the multiple cross-sectional images.

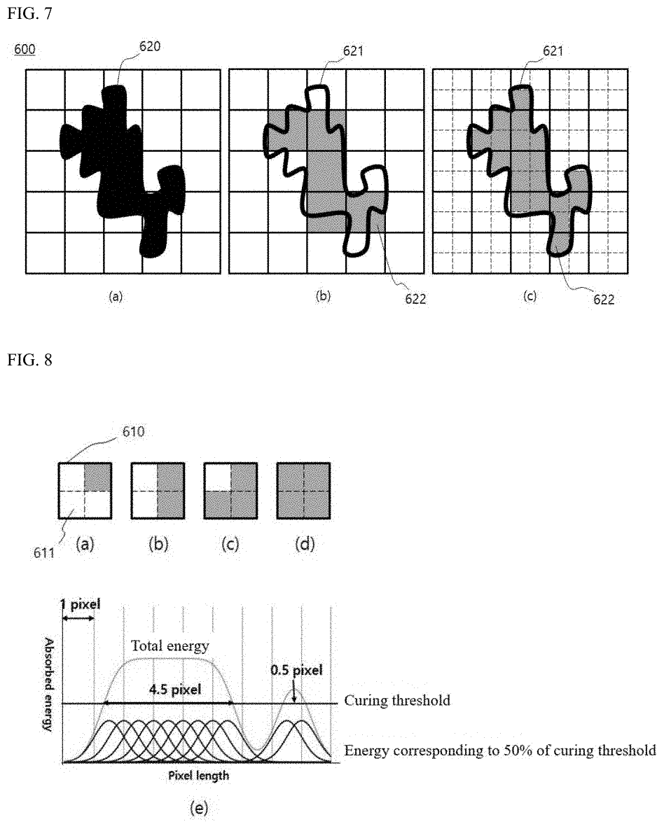

FIG. 7 is a view illustrating benefits of the pixel division step (S200) of the 3D printing method according to one embodiment of the present invention.

FIG. 7(a) shows a cross-sectional image 620 of an object to be modeled, which is projected on a photocurable material 600.

FIG. 7(b) shows a shape modeled by printing pixels of a conventional 3D printer, wherein the thick solid line represents a curing target region 621 to be modeled according to the cross-sectional image 620 of the object.

FIG. 7(c) shows division of each printing pixel into four segments using the dotted lines. Division of each printing pixel into four segments as shown in the drawing can provide a fourfold increase in printing resolution.

The spatial light modulator (200 of FIG. 4) may illuminate the photocurable resin contained in the tank (300 of FIG. 4) while being moved stepwise along a specific path across the segments by a distance corresponding to half the pixel width by the positioning stage (500 of FIG. 4), whereby a printing result as shown in FIG. 7(c) can be obtained.

Although each pixel is shown as being divided into four segments in FIG. 7(c), the present invention is not limited thereto.

FIG. 8 is a view illustrating the illumination algorithm generation step (S300) of the 3D printing method according to one embodiment of the present invention.

In one embodiment of the present invention, in which each printing pixel 610 is divided into four segments 611, there are four cases regarding the number of segments to be cured, as shown in FIG. 8(a) to FIG. 8(d).

FIG. 8(a) shows the case in which one of the four segments is to be cured, FIG. 8(b) shows the case in which two segments are to be cured, FIG. 8(c) shows the case in which three segments are to be cured, and FIG. 8(d) shows the case in which the entire pixel 610 is to be cured.

The illumination algorithm may be implemented such that an energy greater than or equal to the curing threshold of the photocurable resin is accumulated on a segment 611 to be cured (S300).

In addition, the illumination algorithm may be implemented such that an energy less than the curing threshold is accumulated on segments other than the segment 611 to be cured (S300).

FIG. 8(e) shows that, assuming light delivered to the photocurable resin has an energy corresponding to 50% of the curing threshold of the photocurable resin, cumulative illumination with the light can provide an energy greater than or equal to the curing threshold of the photocurable resin. Accordingly, the photocurable resin can be cured when cumulatively illuminated with the light having an energy less than the curing threshold of the photocurable resin until an energy greater than or equal to the curing threshold is accumulated thereon.

Thus, the illumination algorithm may be implemented such that the photocurable resin is illuminated at different intensities on a per-pixel basis while the illumination region is moved along a specific path across the segments 611 of the pixel 610 as shown in FIG. 8(a) to FIG. 8(d) to allow a curing target region to receive an energy greater than or equal to the curing threshold through cumulative illumination (S300).

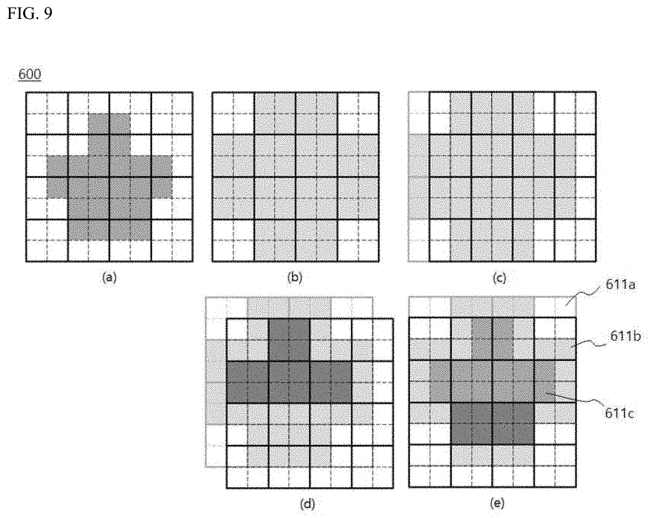

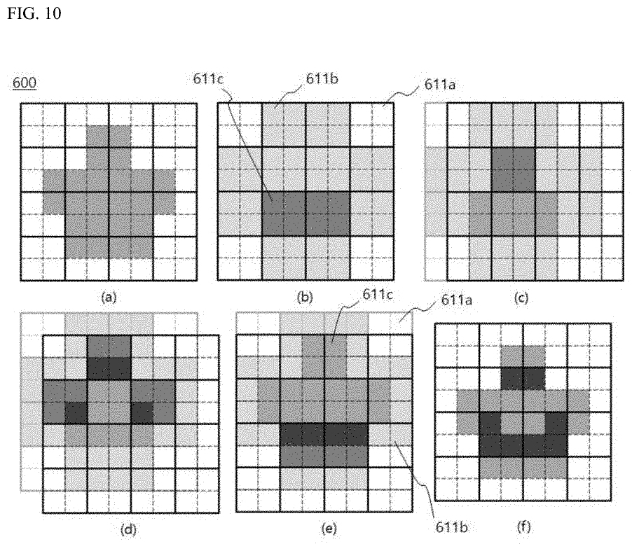

Next, an example of illumination based on the illumination algorithm will be described with reference to FIG. 9 to FIG. 10.

FIG. 9 and FIG. 10 are views illustrating the illumination step (S400) based on the illumination algorithm of the 3D printing method according to different embodiments of the present invention.

FIG. 9(a) and FIG. 10(a) shows a region to be cured according to one embodiment. Here, an illumination region is assumed to be moved clockwise.

FIG. 9 shows an example in which illumination is performed at the same intensity, and FIG. 10 shows an example in which illumination is performed at different intensities according to the number of segments to be cured in each pixel, as described with reference to FIG. 8.

When each pixel is divided into four segments as shown in FIG. 9, the illumination algorithm may include performing illumination four times, that is, moving the illumination region four times along a specific path.

FIG. 9(b) is a primary illumination step in which all pixels having a segment corresponding to the region to be cured shown in FIG. 9(a) are illuminated at an intensity less than the curing threshold of the photocurable resin.

FIG. 9(c) is a secondary illumination step in which illumination is performed at an intensity less than the curing threshold of the photocurable resin with the illumination region offset to the right by one segment from the position shown in FIG. 9(b). In this embodiment, in step (c), some pixels 610 may not be illuminated to prevent a region other than a target region from being cured.

FIG. 9(d) is a tertiary illumination step in which illumination is performed at an intensity less than the curing threshold of the photocurable resin with the illumination region offset downward by one segment from the position shown in FIG. 9(c). In this embodiment, segments illuminated in both step (b) and step (d) can be cured since an energy greater than or equal to the curing threshold is accumulated on the segments through cumulative illumination.

FIG. 9(e) is a quaternary illumination step in which illumination is performed at an intensity less than the curing threshold of the photocurable resin with the illumination region offset to the left by one segment from the position shown in FIG. 9(d). In this embodiment, segments illuminated in both step (b) and step (e) can be cured since an energy greater than or equal to the curing threshold is accumulated on the segments through cumulative illumination. In addition, segments illuminated twice or more through step (b) to step (e) can be cured since an energy greater than or equal to the curing threshold is accumulated on the segments through cumulative illumination.

In the embodiment shown in FIG. 9, light delivered to the photocurable resin may have an energy corresponding to 50% to less than 100% of the curing threshold of the photocurable resin. Accordingly, a segment 611c illuminated with the light twice or more can be cured since an energy corresponding to 100% or more of the curing threshold is accumulated on the segment. Conversely, a non-illuminated segment 661a and a segment 611b illuminated with the light once cannot be cured since the corresponding segments receive an energy corresponding to less than 100% of the curing threshold.

When each pixel is divided into four segments as shown in FIG. 10, the illumination algorithm may include performing illumination four times.

FIG. 10(b) is a primary illumination step in which, among pixels to be cured, pixels, four segments of which are all to be cured, are illuminated at an intensity higher than or equal to the curing threshold of the photocurable resin and pixels, three or less segments of which are to be cured, are illuminated at an intensity less than the curing threshold of the photocurable resin.

FIG. 10(c) is a secondary illumination step in which illumination is performed at an intensity less than the curing threshold of the photocurable resin with the illumination region offset to the right by one segment from the position shown in FIG. 10(b).

FIG. 10(d) is a tertiary illumination step in which illumination is performed at an intensity less than the curing threshold of the photocurable resin with the illumination pattern offset downward by one segment from the position shown in FIG. 10(c). In this embodiment, segments illuminated in both step (b) and step (d) can be cured since an energy greater than or equal to the curing threshold is accumulated on the segments through cumulative illumination. Here, although there can be segments cumulatively illuminated in all the steps (b), (c), and (d), these segments correspond to a segment to be cured.

FIG. 10(e) is a quaternary illumination step in which illumination is performed at an intensity less than the curing threshold of the photocurable resin with the illumination region offset to the left by one segment from the position shown in FIG. 10(d). In this embodiment, segments illuminated in both step (b) and step (e) can be cured since an energy greater than or equal to the curing threshold is accumulated on the segments through cumulative illumination. Here, segments illuminated twice through step (b) to step (e) can also be cured since an energy greater than or equal to the curing threshold through is accumulated on the segments through cumulative illumination. Here, although there can be segments illuminated three or more times through steps (b), (c), (d), and (e), these segments correspond to a segment to be cured.

FIG. 10 shows a result of executing the algorithm as described above.

Although there are segments illuminated three or more times, these segments correspond to a segment to be cured, thus hardly affecting a result of printing.

In the embodiment shown in FIG. 10, the intensity of light delivered to the photocurable resin may be determined according to segments to be cured of each pixel, whereby all pixels, excluding pixels located at the boundary of the cross-sectional image of the 3D model, can be cured by performing illumination once without additional calculation.

In the 3D printer employing the 3D printing method using cumulative illumination along the specific path according to the present invention, the illumination algorithm may be an algorithm for controlling the digital micro-reflector 220 of the spatial light modulator 200, the light source 210, the stacking stage 400, and the positioning stage 500.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. In addition, these modifications and the like are not to be regarded as a departure from the spirit and prospect of the present invention.

### LIST OF REFERENCE NUMERALS

1: 3D printer using cumulative illumination along specific path
100: Housing
110: Door
120: Display
200: Spatial light modulator
210: Light source
220: Digital micro-reflector
221: Micromirror
221a: Micromirror in ON position
221b: Micromirror in OFF position
230: Imaging lens
240: Controller
300: Tank
310: Tank frame
320: Transparent fluorinated ethylene propylene (FEP) film
400: Stacking stage
410: Z-axis linear rail
420: Stacking plate
500: Positioning stage
510: X-axis linear rail
520: Y-axis linear rail
600: Photocurable material to be modeled
610: Pixel
611: Pixel segments
611a: Pixel not to be illuminated
611b: Segment receiving energy less than curing threshold
611c: Segment receiving energy greater than or equal to curing threshold
620: Cross-sectional images of object to be modeled
621: Curing target region
622: Cured region
S100: 3D model slicing step
S200: Pixel division step
S300: Illumination algorithm generation step
S400: Illumination step
S500: Stacking step

What is claimed is:

1. A 3D printer using cumulative illumination along a specific path, the 3D printer comprising:
a tank containing a photocurable resin;
a spatial light modulator disposed under the tank and selectively delivering light to a specific region of the photocurable resin, the spatial light modulator comprising a light source;
a positioning stage disposed under the spatial light modulator and moving the spatial light modulator along multiple axes; and
a controller controlling the spatial light modulator and the positioning stage,
wherein the controller controls the spatial light modulator and the positioning stage such that the spatial light modulator is moved along a specific path and regions of the photocurable resin illuminated with the light partially overlap one another to allow a cumulatively illuminated region to be cured.

2. The 3D printer according to claim 1, wherein the controller controls the positioning stage to move the spatial light modulator stepwise along the specific path by a distance less than a pixel width.

3. The 3D printer according to claim 2, wherein:
the spatial light modulator further comprises a digital micro-reflector comprising an array of micromirrors each selectively reflecting the light from the light source, the number of micromirrors corresponding to the number of pixels; and
the controller controls the digital micro-reflector to reflect the light at a different intensity for each pixel along the specific path.

4. The 3D printer according to claim 2, wherein:
the spatial light modulator further comprises a digital micro-transmitter comprising an array of LCD cells each selectively transmitting the light from the light source, the number of LCD cells corresponding to the number of pixels; and
the controller controls the digital micro-transmitter to transmit the light at a different intensity for each pixel along the specific path.

5. The 3D printer according to claim 2, wherein:
the spatial light modulator further comprises a digital microcell reflector comprising an array of LCoS cells each selectively reflecting the light from the light source, the number of LCoS cells corresponding to the number of pixels; and
the controller controls the digital microcell reflector to reflect the light at a different intensity for each pixel along the specific path.

6. A 3D printing method using cumulative illumination along a specific path, the 3D printing method comprising:
slicing a target 3D model into multiple cross-sectional images;
dividing each pixel of the cross-sectional image into multiple segments;
generating an illumination algorithm for modeling the multiple cross-sectional images such that regions illuminated with light overlap one another with reference to the segments along the specific path;
delivering the light to a photocurable resin along the specific path based on the illumination algorithm; and
stacking a photocured layer of the photocurable resin.

7. The 3D printing method according to claim 6, wherein the illumination algorithm is implemented such that the light is delivered to the photocurable resin while moving stepwise along the specific path by a distance less than a pixel width.

8. The 3D printing method according to claim 7, wherein the illumination algorithm is implemented such that the light is delivered to the segment to be cured at a different intensity for each pixel along the specific path.

9. The 3D printing method according to claim 8, wherein the illumination algorithm is implemented such that the light has an energy less than a curing threshold of the photocurable resin and an energy greater than the curing threshold of the photocurable resin is accumulated on the segment to be cured.
